(19) United States
(12) Patent Application Publication
(10) Pub. No.: US 2005/0220352 A1
(43) Pub. Date: Oct. 6, 2005

(54) Video encoding with constrained fluctuations of quantizer scale

(76) Inventor: Armand Victor Wemelsfelder, Krimpen a/d Ijssel (NL)

Correspondence Address: PHILIPS INTELLECTUAL PROPERTY & STANDARDS, P.O. BOX 3001, BRIARCLIFF MANOR, NY, 10510, US

(21) Appl. No.: 10/509,412

(22) PCT Filed: Feb. 27, 2003
(86) PCT No.: PCT/IB03/00870

§ 371 Date: Sep. 23, 2004

(30) Foreign Application Priority Data
Mar. 28, 2002 (EP) 02076264.7

(51) Int. Cl. G06K 9/36; G06K 9/46

(52) U.S. Cl. 382/232

(57) ABSTRACT

During video compression quantizer scale values for respective blocks under control of a complexity of a content of image information. The temporal and or spatial fluctuations of the quantizer scale values are dampened, for example by low pass filtering provisionally selected quantizer scale values. The quanitizer scale values are use to quantize the video data. The quantizer scale values may also be used during transcoding.

The invention relates to a method of encoding video data and a system implementing such a method.

An article titled “On performance gains in MPEG-2 video coding via a rate-distortion optimal route” by W. M. J. Coene and G. J. Keesman, published in “Signal Processing” 55 (1996) pp. 369-374, discloses methods of computing MPEG encoded video data. The MPEG video encoding standard provides for compression of video information. Video frames are coded as I (Intra) frames that are encoded by themselves or P and B frames that are encoded in terms of updates to other frames. Video frames are divided into blocks (MPEG distinguishes blocks and macroblocks, the latter comprising a number of blocks with information from different color channels, but since this does not affect the invention, the general term “block” will be used indiscriminately for blocks and macroblocks unless mentioned otherwise). Some blocks are made zero, a DCT (Discrete Cosine Transform) coefficients are computed of the video information in each remaining block, the coefficients are quantized and the quantized coefficients are encoded into an MPEG signal.

Encoding by means of updates, zeroing blocks and quantizing are the main contributors to compression of video information in MPEG. Quantizing involves replacing the coefficients with quantized coefficients selected from a limited set of available values. The limited set is characterized by a quantizer scale value Q, which corresponds to the difference between successive available values. Replacement of the coefficients by quantized coefficients reduces the amount of information that is needed to encode the coefficients, be it at the expense of introducing distortion of the image by means of rounding errors due to the differences between the original coefficients and the quantized coefficients. In an MPEG signal the quantizer scale value Q may be varied from block to block, so as to select an optimal balance between compression and distortion of the encoded signal.

The article by Coene and Keesman discloses an optimization method for selecting optimal compression parameters, including the quantizer scale values. A measure of distortion is minimized under the constraint that no more than a certain amount of information (bit-rate) may be used to encode the video signal. The particular measure of distortion used in this method is not disclosed, but presumably an aggregate of distortions of individual frames is used.

The article shows that in prior methods the distortion of I frames on one hand differed the distortion of B and P frames on the other hand. Thus, the distortion varied periodically with the so-called group of frame frequency (a group of frames containing an I frame and surrounding B and P frames). In one embodiment of the method of the article reduces this variation of distortion was reduced by optimizing an aggregate of the distortions of a plurality the frames in such a group. In another embodiment this variation was reduced by making the distortion of all frames equal.

However, in the known method of encoding, human viewers still notice visual artifacts for some video signals when the encoded signal is decoded. For instance, at low encoding bit-rates a heartbeat effect may be observed due to alternating periods of better and worse coding of blocks. This heartbeat effect is most noticeable in difficult scenes, for instance, during zooming in on or out of a particular object, or at edges of relatively uniform surfaces, which are liable to have been encoded with fewer bits and are therefore prone to more errors. This effect may also be present in transcoded data streams and is then due to the buffer regulation algorithm.

It is an objective of the invention to reduce the above mentioned heartbeat effect.

The invention is based on the realization that the noticeable distortion due to quantization is not so much a matter of distortion of frames, i.e. difference between compressed and uncompressed images, but rather a matter of local variation of the distortion. This effect is not measured by normal aggregate measures of distortion.

By using the encoding method according to the invention, the fluctuations of the quantizer scale of blocks at the same position in the frames as a function of time and/or in the same image as a function of position are dampened. In an embodiment of the invention, a spatial and/or temporal filter is applied over the pre-selected quantizer scale values, thereby limiting a change in the quantization scale as a function of time and/or position.

The invention aims to locally constrain fluctuations about a trend around which the quantizer scale may fluctuate. The quantizer scale may follow the trend, but temporal or spatial fluctuations around the trend are constrained, so that the effect of fluctuations in a local environment in the temporal or space domain is damped. The invention further relates to an encoder an audiovisual device, a data container device, a computer program and a data carrier device on which a computer program is stored.

In an embodiment the method is applied to transcoding of a video stream that has already been quantized. Thus generation of artifacts during transcoding is minimized.

In another embodiment estimated motion vectors are used to select blocks in different frames, that are related to each other by the motion vectors. The provisionally selected quantization values for the blocks that found to successively correspond with each other in successive frames are temporally low-pass filtered.

Further objects, elaborations, modifications, effects, and details of the invention appear from the following description, in which reference is made to the drawing.

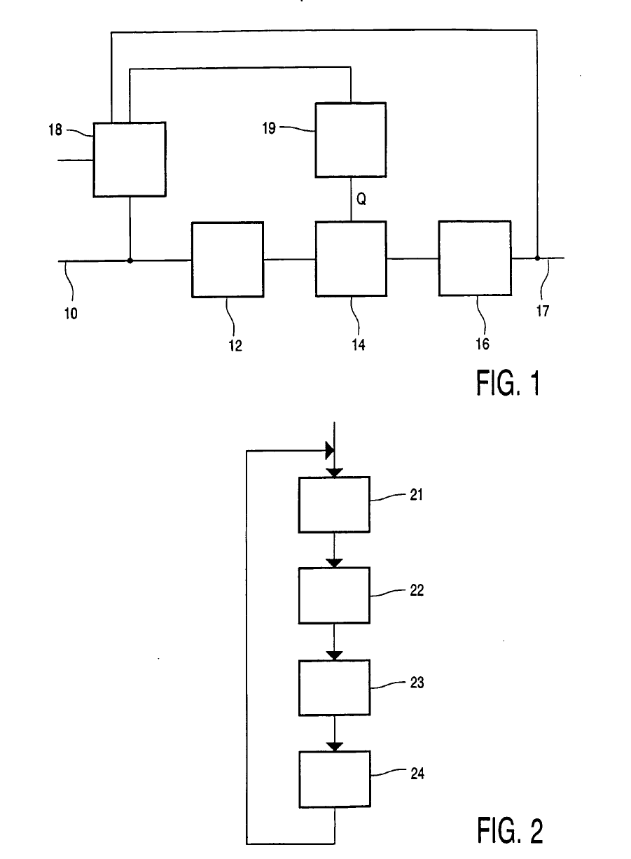

FIG. 1 shows an encoding apparatus;

FIG. 2 shows a flow diagram of an encoding method;

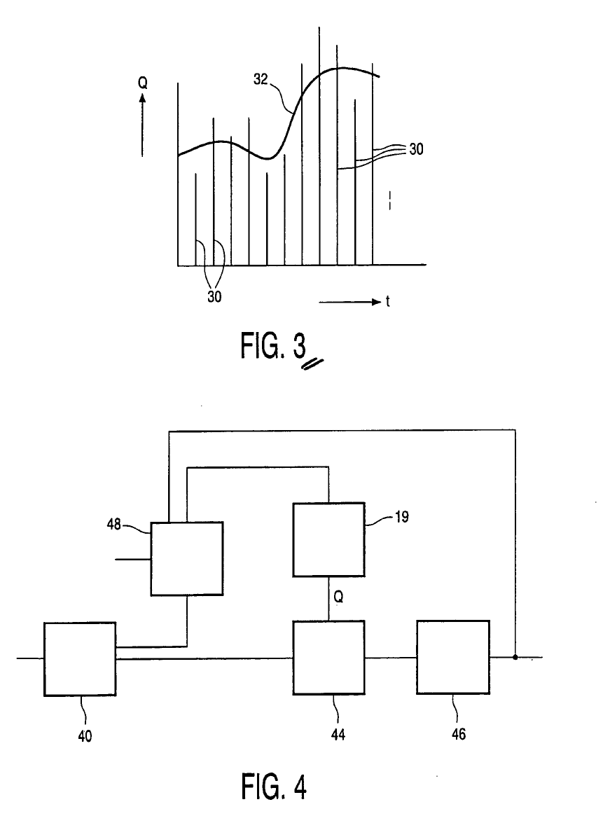

FIG. 3 shows a graph of quantizer scale as a function of time

FIG. 4 shows a transcoding apparatus.

FIG. 1 shows an encoding apparatus. The encoding apparatus has an input and an output 17 and the apparatus contains a pre-processor 12, a quantizer 14, a packager 16, a quantizer scale selector 18 and a quantizer scale filter 19. The input is coupled to the output via, successively, pre-processor 12, quantizer 14 and packager 16. Quantizer scale selector 18 has an input coupled to input 10 and an output coupled to a quantizer scale input of quantizer 14 via quantizer scale filter 19.

FIG. 2 will be used to explain operation of the apparatus in terms of MPEG encoding. In a first step 21 during operation video input information is supplied to input 10. In the first step 21 pre-processor 12 pre-processes the video input information, splitting frames into blocks, performing a DCT (Digital Cosine Transform) of video information in each block. Pre-processor 12 supplies the resulting transform coefficients to quantizer 14.

In a second step 22 quantizer scale selector 18 pre-selects quantizer scale values Qp, quantizer scale filter 19 filters these pre-selected quantizer scale values Qp temporally and/or temporally and supplies the filtered quantizer scale values Qf to quantizer 14.

In a third step 23 quantizer 14 quantizes the coefficients received from pre-processor 12, i.e. it replaces the received coefficients by nearby quantized coefficients from a limited set of quantized values and supplies the quantized coefficients to packager 16. This may be done for example by dividing the coefficients of a block (optionally minus an offset) by the quantizer scale value and taking the integer part of the quotient as quantized value. In a fourth step 24 packager 16 encodes and packages the quantized coefficients into an MPEG compatible signal and supplies that signal to output 17. The steps 21, 22, 23, 24 are periodically repeated as new frames come in.

In second step 22 quantizer scale selector 18 pre-selects quantizer scale values Qp for respective blocks in respective frames of the incoming video information. Quantizer scale selector 18 supplies the pre-selected quantizer scale values Qp to quantizer 14 via quantizer scale filter 19 to control the step size between successive quantized values in the limited set of quantized values from which quantizer 14 selects the quantized coefficients.

Any known method of selecting the quantizer scale values may be used to pre-select the quantizer scale values Qp. In one example quantizer scale selector 18 receives a bit-rate selection signal and pre-selects the quantizer scale values Qp so that on average the bit rate of the output signal at output 17 does not exceed the selected bit rate. The quantizer scale selector 18 computes a measure of complexity for each block and allocates individual bit rates to each block in proportion to the complexity and so that the aggregate bit-rate of all blocks does not exceed the selected bit-rate. The quantizer scale value Qp of each block is then selected so as no to exceed the bit-rate allocated to that block.

Quantizer scale selector 18 supplies the pre-selected quantizer scale values Qp to quantizer 14 via quantizer scale filter 19. Quantizer scale filter 19 performs a temporal and/or spatial low pass filter operation on the pre-selected quantizer scale values Qp and supplies the low pass filtered quantizer scale values Qf to quantizer 14.

It will be appreciated that second step may involve a certain amount of lookahead. That is, pre-selected quantizer scale values may be computed for blocks of a frame before the blocks of preceding frames and/or preceding blocks in the same frame are quantized, so as to select the quantizer scale value Qf for those blocks of preceding frames and/or preceding blocks in the same frame. Thus, account may be taken of pre-selected quantizer scale values of future blocks.

FIG. 3 shows a graph 30 of pre-selected quantizer scale values Qf selected by quantizer scale selector 18 for blocks at the same pixel positions in successive frames of video information as a function of time (i.e. frame number). FIG. 3 also shows a graph 32 of temporally filtered quantizer scale values Qf, as produced by quantizer scale filter 19. It will be noted that the filtered quantizer scale values Qf 32 follow the general trend of the preselected quantizer scale values Qp, but that fluctuations around the trend are suppressed.

Similar graphs may be drawn for the quantizer scales Qp and Qf as a function of the position of the blocks with which these scales are associated in a frame.

Any method may be used to filter the pre-selected quantizer scale values Qp 30. For example one might take the median of a number of successive pre-selected quantizer scale values Qp in a window of frames around the frame for which the filtered quantizer scale value Qf is selected. This removes fluctuations but allows sudden changes, for example when the content of the block changes abruptly. In another example filtering is realized by computing an average of successive pre-selected quantizer scale values Qp in a window of frames around the frame for which the filtered quantizer scale value Qf is selected. The average may be a weighted average, which assigns more weight to pre-selected quantizer scale values Qp from frames close to the frame for which the filtered quantizer scale value Qf is selected.

In another embodiment motion information is used to support filtering. In this case, filter 19 temporally filters the quantization values that are selected for blocks in different frames that are related to each other by motion vectors. That is, if it is estimated that the content of a first block in a first frame moves to a second block in a second frame and from there to a third block in a third frame and so on, temporal filtering is applied to the sequence of quantizer scale values formed by the quantizer scale values of the first block, the second block, the third block and so on and the filtered quantizer scale values are used to quantize the corresponding blocks. Again this reduces visible artifacts. The motion vectors may be obtained in any way, for example from the motion vectors used in MPEG encoding.

It will be appreciated that, although the implementation shown in FIG. 1, using a quantizer scale value filter 19 is advantageously simple, other means for reducing fluctuations may be used. For example, a search may be used for a set of quantizer scale values that minimizes distortion without exceeding a predetermined bit-rate. In this case, the apparatus should use a modified measure of distortion that assigns an increased value to the distortion in case of fluctuations in the quantizer scale values. This may be done, for example, by using a measure of distortion based on the deviations between the original image and the encoded image, added to squares of differences between actually used quantizer scale value Qf at corresponding positions in adjacent frames and/or between adjacent positions in the same frame.

It will also be appreciated that, although the principles of reducing fluctuations in quantizer scale have been described, many modifications may be needed to account for peculiar details of the coding standard. For example, in case of the MPEG standard only a limited number of quantizer scale values are allowed. Therefore, the filtered quantizer scale values Qf should be selected from this limited number of values, but the preselected quantizer scale values Qp may be selected freely. Also the MPEG standard imposes some restrictions on differences between the quantizer scale values that may be used for different blocks in a macroblock. This can be realized for example by selecting filtered quantizer scale values Qf per macroblock.

Furthermore, in the MPEG standard most changes in the quantizer scale value (e.g. changes between horizontally adjacent blocks) have to be signaled with additional signals, which are not needed when the quantizer scale does not change. The additional signals lead to increases in the number of bits in the compressed signal. Therefore, it may be desirable to weigh both the noticeable distortion due to changes of the quantizer scale and the increases in the number of bits in the compressed signal.

The invention may be applied to compression that produces data for transmission or for storage of video information. The invention can be applied to data being stored to a data container device like a floppy disk a Digital Versatile Disc or a Super Audio CD, or a master or stamper for manufacturing DVDs or SACDs. The invention may also be applied to transcoding of compressed video information.

FIG. 4 shows a transcoding apparatus. The transcoding apparatus the apparatus contains a partial decoding unit 40, a requantizer 44, a packager 46, a quantizer scale selector 48 and a quantizer scale filter 49. The input of the transcoder is coupled to the output via, successively, partial decoding unit 40, requantizer 44 and packager 46. Quantizer scale selector 48 has an input coupled to an output of the partial decoder and an output coupled to a quantizer scale input of requantizer 44 via quantizer scale filter 49.

In operation the transcoder receives compressed encoded data with signal values that have been quantized using a first quantizer scale. The transcoder requantizes the signal values with a second quantizer, for example in order to increase the compression rate. Partial decoding unit 40 partially decodes a received compressed signal, and supplies information representing the quantized signal value from the received signal to the requantizer 44. Requantizer 44 selects a new quantized value for each signal value, so that the new quantized value belongs to a quantization scale indicated by filter 49. Packager 46 repackages the information from the stream into a new encoded stream, encoding the new quantized values.

Selector 48 selects quantization scales. This is done for example for each block in proportion to the quantization scales used in corresponding block in the incoming signal (the proportionality factor being selected so that a measured bit rate at the output on average corresponds to an externally demanded bit rate). Filter 49 spatially and/or temporally filters the selected quantization scale values as described for FIG. 1.

Although separate hardware units have been shown in an implementation of the invention, it will be appreciated that the functions of one or more of these units may be combined in a single unit. For example, preselection and filtering, performed by units 18, 19, may be executed by a single unit. Furthermore, the components of the apparatus shown in FIG. 1 may be physically distributed over a number of apparatuses, while logically regarded as a single apparatus. Although the invention has been described in terms of compression according to the existing MPEG standard, it may of course be applied to any form of compression, for example according to future MPEG standards or nay other standard.

Also, various elements may be implemented with a computer system programmed with suitable computer programs that implement the invention, the programs at least including instructions for performing steps of a method according to the invention when run on a computer system or enabling a general propose computer system to perform functions of a computer system according to the invention. Such a computer program may be provided on a data carrier, such as a CD-rom or diskette, stored with data loadable in a memory of a computer system, the data representing the computer program. A data carrier may further be a data connection, such as a telephone cable or a wireless connection transmitting signals representing a computer program according to the invention.

In the foregoing specification, the invention has been described with reference to specific examples of embodiments of the invention. The specifications and drawings are, accordingly, to be regarded in an illustrative rather than in a restrictive sense.

1. A method of encoding a digital video stream, the method comprising the steps of
dividing frames of the video stream into blocks;
selecting quantizer scale values for respective ones of the blocks, under control of a complexity of a content of image information in the respective ones of the blocks, wherein an effect, of fluctuations of the complexity as a function of time and/or position of the respective ones of the blocks, on temporal and or spatial fluctuations of the quantizer scale values is dampened;
computing video data quantized according to the selected quantizer scale values;
generating an encoded video stream comprising the quantized video data.

2. A method of encoding a digital video stream according to claim 1, wherein the selecting step comprises
preselecting preliminary values for the quantizer scale values for respective ones of the blocks, under control of the complexity;
temporally and or spatially low-pass filtering the preliminary values to determine the quantizer scale values to be used in the computing step.

3. A method of encoding a digital video stream according to claim 1, wherein the digital video stream is an encoded video stream comprising information representing quantized input values, and requantizing the quantized input values according to the selected quantizer scale values.

4. A method of encoding a digital video stream according to claim 1, the method comprising relating a succession of blocks from successive frames to each other on the basis of estimated motion vectors, the selecting step comprising temporally low-pass filtering a succession of quantization values that are provisionally selected for the successive blocks respectively.

5. A system for encoding a digital video stream, the system comprising
a pre-processor arranged to compute image information for respective blocks of pixels in frames of the video stream;
a quantizer arranged to quantize the computed image information, using block dependent quantizer scale values;
an encoded video stream generator arranged to generate an encoded stream that encodes the quantized video data;
a quantization scale selector arranged to select the quantizer scale values for respective ones of the blocks, under control of a complexity of a content of image information in the respective ones of the blocks, wherein an effect, of fluctuations of the complexity as a function of time and/or position of the respective ones of the blocks, on temporal and or spatial fluctuations of the quantizer scale values is dampened.

6. A system according to claim 5, the system comprising
a preselector for preselecting preliminary values for the quantizer scale values for respective ones of the blocks, under control of the complexity;
a low pass filter unit for temporally and or spatially low-pass filtering the preliminary values to determine the quantizer scale values.

7. A system according to claim 5, the pre-processor being arranged to compute the image information from an incoming encoded video stream with quantized input signal values, the quantizer requantizing the quantized input values.

8. A system according to claim 6, the filter temporally low pass filtering preselected quantization that are pre-selected for a succession of selected blocks in different frames, the selected blocks being related to each other by motion vectors estimated for the frames.

9. A computer program product comprising a computer program with instructions for programming a computer to execute the method according to claim 1.
